(19) United States
(12) Patent Application Publication
(10) Pub. No.: US 2015/0284835 A1
(43) Pub. Date: Oct. 8, 2015

(54) METHOD OF MAKING ENHANCED SURFACE COATING FOR LIGHT METAL WORKPIECE

(71) Applicant: GM Global Technology Operations LLC, Detroit, MI (US)

(72) Inventors: Yanfeng Ge, Luoyang (CN); Bailing Jiang, Xi'an (CN); Ming Liu, Shanghai (CN)

(21) Appl. No.: 14/681,430

(22) Filed: Apr. 8, 2015

Related U.S. Application Data
(63) Continuation of application No. PCT/CN2014/074884, filed on Apr. 8, 2014.

(51) Int. Cl. C23C 8/36; C23C 8/04; C25D 13/06; C23C 28/00; B60B 3/10; C25D 13/12; B05D 1/06; C23C 8/80

(52) U.S. Cl. CPC C23C 8/36; B05D 1/06; C23C 8/04; C23C 8/80; C23C 28/00; B60B 3/10; C25D 13/12; C25D 13/06; B60B 2360/106; B60B 2360/324; B60B 2310/654; B60B 2900/141

(57) ABSTRACT

A light metal workpiece with enhanced surface protection. The workpiece comprises a metal or alloy matrix having an exposed surface. A corrosion resistant oxide layer is formed in at least a portion of the exposed surface using a micro-arc oxidation technique. A first coating is applied onto at least a portion of the oxide layer using an electro-coating technique and is configured to seal the oxide layer. A second coating is applied onto at least a portion of the first coating, the second coating comprising a powder coating material. An appearance coating may optionally be applied onto at least a portion of the second coating, wherein the appearance coating includes at least one of a base coat, a color coat, and a clear coat.

### CROSS-REFERENCE TO RELATED APPLICATIONS

This application claims the benefit and priority of International Application PCT/CN2014/074884 filed on Apr. 8, 2014. The entire disclosure of the above application is incorporated herein by reference.

### FIELD

The present disclosure relates to coatings and methods of applying surface treatments for increased corrosion resistance of metals and alloys susceptible to corrosion.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present technology.

Alloy road wheels with high magnesium or aluminum content are not uncommon on specialty and racing vehicles. The use of the wheels in less expensive passenger vehicles has, however, been limited to a few production sports cars. By way of example, galvanic corrosion is a design consideration in high magnesium content alloy wheels when mated to steel or cast iron wheel hub and brake components. Frequently, these components may spend much of their service life in damp or wet conditions, unfortunately often with road salts, which accelerates the galvanic corrosion reactions. Various coatings have been applied to light metal workpieces and substrates, such as alloy wheels, for increasing corrosion protection, but they have had many drawbacks. For example, workpieces having only thick oxide layers formed thereon have been used, but were often brittle and prone to cracking. Workpieces having powder coating materials directly applied to oxide layers have shown poor adhesion. Workpieces having chemical passivation techniques in combination with an oxide layer have been used, but have had poor chipping resistance. Still further, workpieces simply having an electrocoating layer provided on an oxide layer have also been used, but may yield a product with poor scratch corrosion and poor thermal shock resistance. In yet other alternatives, wheels may be provided as two-component assemblies having inner and outer portions, with the inner portion galvanically isolating the outer portion from the steel or cast iron wheel hub and brake components. However, such two component assemblies may not always be desirable.

Accordingly, there remains a need for improved surface treatments for increased corrosion resistance of light metals and alloys susceptible to corrosion.

### SUMMARY

This section provides a general summary of the disclosure, and is not a comprehensive disclosure of its full scope or all of its features.

In various aspects, the present teachings provide a light metal workpiece with enhanced surface protection. The workpiece comprises a metal or alloy matrix having an exposed surface. A corrosion resistant oxide layer is formed in the exposed surface using a micro-arc oxidation technique. A first coating is applied onto the oxide layer using an electro-coating technique and is configured to seal the oxide layer. A second coating is applied onto the first coating, the second coating comprising a powder coating material.

In other aspects, the present teachings provide a magnesium metal wheel comprising a magnesium metal matrix having an exposed surface. A magnesium oxide ceramic layer is formed on at least a portion of the exposed surface. An electrostatic coating is applied over the magnesium oxide ceramic layer. A powder coating material is applied over the electrostatic coating. In certain aspects, the magnesium oxide ceramic layer is formed having a thickness of from about 5 μm to about 20 μm and has an average pore size of from about 0.1 μm to about 5 μm. The electrostatic coating may comprise an epoxy resin and may be applied having a thickness of from about 15 μm to about 35 μm. The powder coating material may comprise polyurethane and may be applied having a thickness of from about 50 μm to about 150 μm.

In still other aspects, the present teachings include a method of providing an enhanced surface coating on a metal or alloy substrate. The method comprises providing a metal or alloy substrate having an exposed surface. An oxide layer is generated on the exposed surface of the substrate using a micro-arc oxidation process. The method includes applying a first coating onto the oxide layer using an electro-coating technique, and applying a powder coating material layer on the first coating. In various aspects, the oxide layer is provided having a porosity of from about 1 μm to about 3 μm. The method may include applying the first coating on the oxide layer within less than about 24 hours after generating the oxide layer, and maintaining the substrate in an environment having humidity conditions of less than about 60% relative humidity after generating the oxide layer and prior to applying the first coating.

Further areas of applicability and various methods of enhancing corrosion protection of light metal workpieces and valve metals will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 is a front plan view of an exemplary wheel assembly according to various aspects of the present disclosure;

FIG. 2 is a cross-sectional view of the wheel assembly taken along the line 2-2 of FIG. 1; and

FIG. 3 is a simplified diagram representation illustrating various coatings that can be applied to a metal matrix according to various aspects of the present disclosure.

It should be noted that the figures set forth herein are intended to exemplify the general characteristics of materials, methods, and devices among those of the present technology, for the purpose of the description of certain aspects. These figures may not precisely reflect the characteristics of any given aspect, and are not necessarily intended to define or limit specific embodiments within the scope of this technology. Further, certain aspects may incorporate features from a combination of figures.

### DETAILED DESCRIPTION

The following description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Spatially relative terms, such as “inner,” “outer,” “beneath,” “below,” “lower,” “above,” “upper,” “on,” and the like, may be used herein for ease of description to describe one element or feature's relationship to another element(s) or feature(s). Spatially relative terms may encompass different orientations of the device in use or operation. As used herein, when one coating, layer, or material is “applied onto,” “applied over,” “formed on,” “deposited on,” etc. a substrate or item, the coating, layer, or material may be applied, formed, deposited on an entirety of the substrate or item, or on at least a portion of the substrate or item.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims.

The present technology generally relates to enhanced surface coatings for light metal workpieces and valve metals. As used herein, the term “valve metal” is used to refer to a metal or metal alloy that can self-grow nano-porous oxide films. The resultant oxide layer formed on a valve metal may well provide some degree of corrosion protection, as it constitutes a physical barrier between the metal and a corrosive environment. However, it may not be aesthetically pleasing, and may not provide proper corrosion resistance for light metal workpieces, such as wheels.

Example valve metals useful with the present technology include aluminum, magnesium, titanium, zirconium, hafnium, chromium, cobalt, molybdenum, vanadium, tantalum, and mixtures and alloys thereof. As is known in the art, valve metals may exhibit electrical rectifying behavior in an electrolytic cell and, under a given applied current, will sustain a higher potential when anodically charged than when cathodically charged.

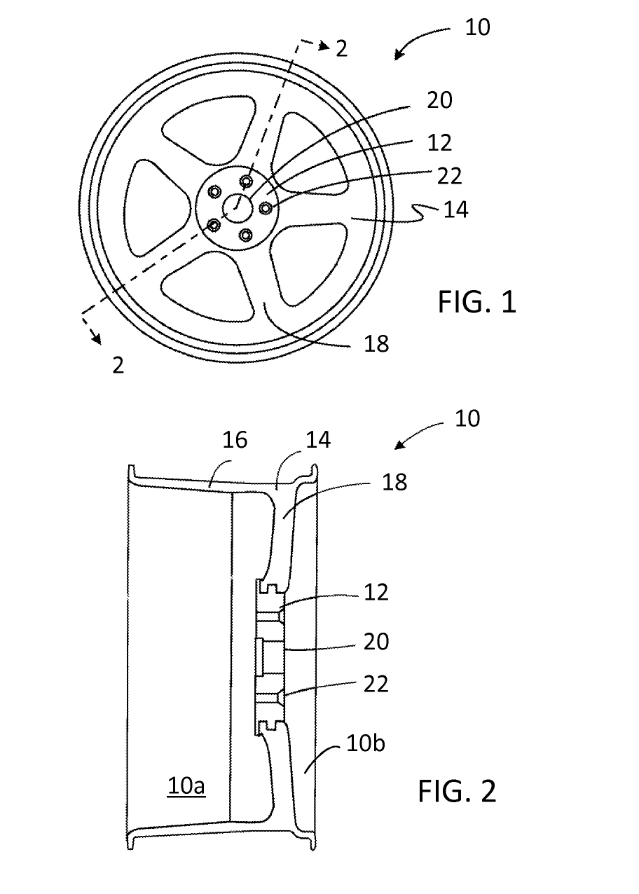

In various aspects, the present teachings provide a light metal workpiece, such as a valve metal or metal alloy, with enhanced surface protection. With reference to FIG. 1, in one aspect of the present disclosure, the light metal workpiece may be a wheel 10, such as an aluminum, magnesium, or alloy wheel. It should be understood that the technology of the present disclosure can generally be used with any wheel design, or any other workpiece or component envisioned to be made from a valve metal that may have an exposed surface subject to a corrosive environment. For example purposes, the wheel 10 may generally be a unitary member or optionally be provided with a center portion 12 coupled with an outer wheel portion 14, as shown. The outer wheel portion 14 may include a rim 16 and may also include one or more spokes 18 extending from the rim 16 in a generally radial direction toward the center wheel portion 12. The wheel portion 12 may include a center opening 20 suitable for a wheel cap (not shown) and may define one or more lug holes 22 useful for attaching the wheel 10 to a vehicle.

Referring to FIG. 2, which is cross sectional view of FIG. 1 taken along the line 2-2, the wheel 10 may have an inboard side 10a and an outboard side 10b. The inboard side 10a generally indicates the side of the wheel 10 that faces the vehicle, and the outboard side 10b generally indicates the side of the wheel 10 that faces away from the vehicle and visible when the wheel 10 is attached to the vehicle.

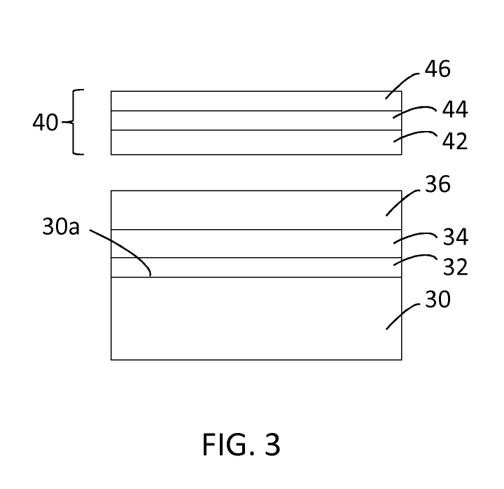

In various aspects, the wheel 10 or other light metal workpiece comprises a metal or alloy matrix having an exposed surface. FIG. 3 is a simplified diagram representation illustrating various coatings that can be applied to a portion or an entirety of an exposed surface of a metal matrix according to various aspects of the present disclosure. The coatings and treatments discussed herein may be applied to the entire workpiece, or portions thereof. For example, both the inboard side 10a and the outboard side 10b of a wheel may be subjected to methods of the present teachings that apply enhanced corrosion protection coatings, but it may be desirable to only apply an appearance layer (discussed in more detail below) to the visible outboard side 10b.

Reference number 30 of FIG. 3 generally indicates the metal matrix, which initially has an exposed surface 30a. The light metal workpiece having the exposed metal matrix surface 30a may undergo various pretreatment processes as is known in the art, including degreasing, descaling, neutralization, and similar washing processes. A corrosion resistant oxide layer 32 may then be formed in the exposed surface 30a using a micro-arc oxidation technique. As shown in FIG. 3, a first coating 34 may be applied onto the oxide layer 32 using an electro-coating technique and may be configured to seal the oxide layer 32. A second coating 36 may then be applied onto the first coating 34, wherein the second coating 36 includes a powdered coating material. A finish or appearance coating 40 may optionally be applied over at least a portion the second coating 36 (for example, the outboard side 10b). As is known in the art, the appearance coating 40 may include one or more coatings that impart a desired color, shine, and/or gloss to the workpiece. By way of example, the appearance coating 40 may include one or more of a base coat 42, a color coat 44, a clear coat 46, and mixtures or combinations thereof. It should be understood that while FIG. 3 shows a distance or spatial gap between the basecoat 42 of the appearance coating 40 and the second coating 36, the appearance coating 40 is indeed applied onto the second coating 36 and the spatial gap is only provided to illustrate the optional nature of the appearance coating 40.

As is known in the art, micro-arc oxidation techniques (“MAO”), sometimes also referred to as plasma electrolytic oxidation, spark anodizing, discharge anodizing, or other combinations of these terms, may involve the use of various electrolytes to work in an electrolytic cell and that help generate a porous oxide layer, or porous oxide ceramic layer, at the exposed surface of metal matrix. By way of example, where the workpiece includes aluminum, the oxide layer or oxide ceramic layer may be formed using MAO techniques to yield a layer of alumina or an alumina ceramic, the composition of which may vary based on the electrolyte and other materials present therein. Where the workpiece includes magnesium, the oxide layer or ceramic oxide layer may be formed using MAO techniques to yield a layer of magnesia or magnesium oxide ceramic. There are many patented and commercial variants of the MAO processes, including those described in U.S. Pat. Nos. 3,293,158; 5,792,335; 6,365,028; 6,896,785; and U.S. patent application Ser. No. 13/262,779, published as U.S. Pub. Pat. App. No. 2012/0031765, each of which is incorporated herein by reference in its entirety. In one example, the MAO process may be performed using a silicate-based electrolyte that may include sodium silicate, potassium hydroxide, and potassium fluoride.

As is generally known in the art, the presence of micropores and/or cracks on the surface of MAO coatings can be considered as both an “opportunity” and a “potential weakness.” By way of an “opportunity,” the presence of a porous outer layer in MAO coatings can significantly improve the mechanical interlocking effect, the bonding area, and stress distribution, resulting in higher bond strength. The presence of a higher pore density on the surface of the MAO coatings increases the effective surface area and thus the tendency of a corrosive medium to adsorb and concentrate into these pores. Thus, the pore density, distribution of pores and interconnectivity of the pores with the remainder of the substrate can be important factors. In various aspects of the present disclosure, the oxide layer 32 or ceramic layer may be generated or formed having a controlled and substantially uniform porosity of from about 0.1 μm to about 5 μm, from about 1 μm to about 3 μm, or from about 0.1 μm to about 1 μm. The oxide layer 32 may be generated or formed having a substantially uniform thickness of from about 2 μm to about 30 μm, from about 4 μm to about 25 μm, or from about 5 μm to about 20 μm.

With regard to the above-mentioned “potential weakness,” the presence of the porous oxide or ceramic layer from the MAO process typically requires the application of a sealing coating. As such, the present disclosure applies a first coating, or electrostatic layer, onto the oxide layer using an electrocoating technique (“e-coating” or electrophoresis coating) that is configured to seal the oxide layer and provide for increased adhesion of optional additional layers applied thereon. Prior to the electrocoating, the workpiece may optionally be washed or immersed in deionized water. Typical sealer systems that may be used in conjunction with the MAO processes may include a wide variety of polymers and resins, including but not limited to, fluoropolymers, acrylic, epoxy, polyester, polysiloxanes, and polyvinylidene fluoride (PVDF). These materials may be applied in the form of electrostatically sprayed coatings, by electrophoretic deposition, or by known dipping or wet spraying techniques. In one presently preferred aspect that can be used with magnesium workpieces such as magnesium or magnesium alloy wheels, an epoxy resin may be used, for example, EPDXY RESIN KATAPHORESIS COATING (EED-060M), commercially available from Unires, or its constituent company Tianjin Youli Chemical Co., Ltd. of Tianjin, China. Generally, the first coating will not contain a significant amount of any chemically active agent therein. The e-coating treatment process may take place from 0 to about 3 minutes using a voltage of between about 160V to about 220V, and cured at a temperature of from about 160° C. to about 180° C. for a curing time of from about 20 to about 30 minutes.

The approaches adopted with the present teachings include applying the first coating on the oxide layer within less than about 30 hours, and preferably less than about 24 hours, less than about 20 hours, or less than about 16 hours after generating or forming the oxide or ceramic oxide layer. In addition to the timing considerations, the present teachings also provide for maintaining the substrate or workpiece in an ambient temperature environment having humidity conditions of less than about 70%, less than about 65%, and preferably less than about 60% relative humidity after generating the oxide layer and prior to applying the first coating. It is envisioned that the timing and environmental conditions disclosed herein may provide increased corrosion resistance between the e-coating layer and the oxide or ceramic layer. In various aspects, the first coating is applied having a substantially uniform thickness of from about 10 μm to about 50 μm, or from about 15 μm to about 40 μm, or from about 15 μm to about 35 μm, or about 30 μm.

As known in the art, a wide range of materials and methods for encapsulation are commercially available that provide for a variety of strategies to create the degree of durability and corrosion resistance. The approaches adopted with the present teachings include applying a second coating onto the first coating that includes a powder coating material. Powder coating materials useful herein may include thermoplastic or reactive polymers commonly used in the art that are typically solid at room temperature. Most powders are reactive one-component systems that liquefy, flow, and then crosslink as a result of treatment with heat. Common polymers that may be used as powder coating materials include polyester, polyurethane, polyester-epoxy (known as hybrid), straight epoxy (fusion bonded epoxy), and acrylics.

In various aspects, the methods of the present teachings include heating the workpiece or substrate having the first coating to a temperature of from about 80° C. to about 100° C. prior to applying the second coating, or powder coating material layer. By way of example, in one aspect, the method of applying the powder coating layer onto the first coating can include electrostatically spraying a wet black resin powder onto the oxide layer of a heated substrate, the resin powder being delivered at a voltage of from about 40kV to about 50kV, or about 45kV, and a current of from about 0.4A to about 0.6A, or about 0.5A. In one presently preferred aspect that can be used with magnesium workpieces having an epoxy resin first coating, the second coating may include a powder coating mainly containing a large portion of polyurethane. It may include, for example, a TIGER DRYLAC® powder coating “wet black” 049/80036, having a high gloss, commercially available from TIGER Coatings GmbH & Co, of Austria.

The methods of the present teachings further include curing and condensing the powder coating layer by placing the workpiece or substrate in a heated environment at a temperature of from about 180° C. to about 200° C., or about 190° C., for a time period of from about 15 minutes to about 25 minutes, or about 20 minutes.

In various aspects, the second coating is applied having a substantially uniform thickness of from about 25 μm to about 150 μm, or from about 50 μm to about 150 μm, or from about 70 μm to about 130 μm, or from about 80 μm to about 120 μm, or about 100 μm. In certain aspects, the first coating can be applied onto the oxide layer having a first thickness, and the second coating can be applied onto the first layer having a second thickness. It may be beneficial to have a powder material coating having a thickness much greater than the electrocoating in order to provide increased corrosion protection. Thus, the approaches adopted with the present teachings may include applying the second layer having a second thickness of from about 1.5 to about 10 times greater than the first thickness of the first coating. Accordingly, by way of example, in certain aspects a first coating having a thickness of about 15 μm may be used with a second coating having a thickness of from about 25 μm to about 150 μm.

It should be understood that the present technology is not dependent on, nor limited to, any particular type of material or production method, and the materials and methods may be varied as desired, based on the intended results. The light metal and alloys provided with the enhanced surface protection coatings disclosed herein have been shown to have superior adhesion qualities, resistance to chipping, resistance to thermal shock, and minimal scratch corrosion.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A light metal workpiece with enhanced surface protection, comprising:
a metal or alloy matrix having an exposed surface;
a corrosion resistant oxide layer formed in at least a portion of the exposed surface using a micro-arc oxidation technique;
a first coating applied onto at least a portion of the oxide layer using an electro-coating technique and configured to seal the oxide layer; and
a second coating applied onto at least a portion of the first coating, the second coating comprising a powder coating material.

2. The light metal workpiece of claim 1, wherein the first coating is applied having a first thickness and the second coating is applied having a second thickness, wherein the second thickness is from about 2 to about 10 times greater than the first thickness.

3. The light metal workpiece of claim 1, wherein the oxide layer is formed having a thickness of from about 5 μm to about 20 μm, the first coating is applied having a thickness of from about 15 μm to about 35 μm, and the second coating is applied having a thickness of from about 50 μm to about 150 μm.

4. The light metal workpiece of claim 1, wherein the oxide layer comprises an average pore size of from about 1 μm to about 3 μm.

5. The light metal workpiece of claim 1, wherein the metal or alloy matrix comprises at least one valve metal selected from the group consisting of aluminum, magnesium, titanium, and mixtures thereof.

6. The light metal workpiece of claim 1, wherein the metal matrix comprises magnesium, the oxide layer comprises a magnesium oxide ceramic, the first coating comprises an epoxy resin, and the second coating comprises polyurethane.

7. The light metal workpiece of claim 1, further comprising an appearance coating applied onto at least a portion of the second coating, wherein the appearance coating comprises at least one of a base coat, a color coat, and a clear coat.

8. A magnesium metal wheel, comprising:
a magnesium metal matrix having an exposed surface;
a magnesium oxide ceramic layer formed on at least a portion of the exposed surface;
an electrostatic coating applied onto a least a portion of the magnesium oxide ceramic layer; and
a powder material coating applied onto at least a portion of the electrostatic coating.

9. The wheel of claim 8, wherein the magnesium oxide ceramic layer is formed having a thickness of from about 5 μm to about 20 μm and an average pore size of from about 0.1 μm to about 5 μm, the electrostatic coating comprises an epoxy resin and is applied having a thickness of from about 15 μm to about 35 μm, and the powder material coating comprises polyurethane and is applied having a thickness of from about 50 μm to about 150 μm.

10. The wheel of claim 8, further comprising an appearance coating further comprising an appearance coating applied over the electrostatic coating, wherein the appearance coating comprises at least one of a base coat, a color coat, and a clear coat.

11. A method of providing an enhanced surface coating on a metal or alloy substrate, the method comprising:
providing a metal or alloy substrate having an exposed surface;
generating an oxide layer on the exposed surface of the substrate using a micro-arc oxidation process;
applying a first coating layer onto the oxide layer using an electro-coating technique; and
applying a second coating layer onto the first coating layer, the second coating layer comprising a powder material coating.

12. The method according to claim 11, further comprising heating the substrate to a temperature of from about 80° C. to about 100° C. prior to applying the second coating layer.

13. The method according to claim 12, wherein applying the second coating layer onto the first coating layer comprises electrostatically spraying a wet black resin powder onto the oxide layer, delivered at a voltage of from about 40 kV to about 50 kV and a current of from about 0.4A to about 0.6A.

14. The method according to claim 11, further comprising curing and condensing the powder material coating by placing the substrate in a heated environment at a temperature of from about 180° C. to about 200° C. for a time period of from about 15 minutes to about 25 minutes.

15. The method according to claim 11, further comprising applying the first coating layer on the oxide layer within less than about 24 hours after generating the oxide layer, and maintaining the substrate in an environment having humidity conditions of less than about 60% relative humidity after generating the oxide layer and prior to applying the first coating layer.

16. The method according to claim 11, wherein the substrate comprises a metal or alloy selected from the group consisting of aluminum, magnesium, titanium, and mixtures thereof.

17. The method according to claim 11, wherein generating the oxide layer comprises maintaining an average pore size in the oxide layer within a range of from about 1 μm to about 3 μm.

18. The method according to claim 11, further comprising applying an appearance coating over the powder coating layer, wherein the appearance coating comprises at least one of a base coat, a color coat, and a clear coat.

19. The method according to claim 11, wherein the oxide layer is generated having a thickness of from about 5 μm to about 20 μm, the first coating layer is provided having a thickness of from about 15 μm to about 35 μm, and the second coating layer is provided having a thickness of from about 50 μm to about 1501 μm.

20. The method according to claim 11, wherein the substrate comprises magnesium, the oxide layer comprises a magnesium oxide ceramic, the first coating layer comprises an epoxy resin, and the second coating layer comprises polyurethane.
